(19) United States
(12) Patent Application Publication
(10) Pub. No.: US 2014/0366125 A1
(43) Pub. Date: Dec. 11, 2014

(54) INFORMATION PROCESSING DEVICE, EXTERNAL DEVICE, SERVER DEVICE, INFORMATION PROCESSING METHOD, INFORMATION PROCESSING PROGRAM AND SYSTEM

(71) Applicant: PIONEER CORPORATION, Kawasaki-shi, Kanagawa (JP)

(72) Inventors: Toshiyuki Murata, Sakado (JP); Yozo Takehara, Arakawa (JP); Shunichiro Nagao, Kawagoe (JP); Yuusuke Takano, Saitama (JP)

(21) Appl. No.: 14/369,135

(22) PCT Filed: Dec. 27, 2011
(86) PCT No.: PCT/JP2011/080323

§ 371 Date: Jun. 26, 2014

(51) Int. Cl. G06F 21/44

(52) U.S. Cl. CPC G06F 21/44
USPC 726/17

(57) ABSTRACT

The information processing device connects with an external device by a first connection unit and a second connection unit different from each other. An identification information specific to the information processing device is transmitted from the information processing device to the external device via the first connection unit, and further transmitted from the external device to the information processing device via the second connection unit. The information processing device compares the specific identification information received from the external device with specific identification information for comparison, stored in advance, to determine whether or not the information processing device and the external device are in a simultaneous connection state in which the information processing device and the external device are connected by the first connection unit and the second connection unit.

### TECHNICAL FIELD

The present invention relates to a method of controlling a connection between an information processing device and an external device by using a plurality of connection means.

### BACKGROUND TECHNIQUE

The Road Traffic Law prohibits a driver of a vehicle from gazing an image displayed on an image display device during driving. An on-vehicle device such as a car navigation device is configured not to display the image of TV and/or DVD during the driving of the vehicle.

By the way, recently, an on-vehicle device such as a car navigation device and a terminal device such as a smartphone are connected and used. For example, there is proposed a technique of transmitting a display image of the smartphone to the on-vehicle device to display it on a display unit of the on-vehicle device, and operating the smartphone by the touch input made to the display unit of the on-vehicle device.

For example, Patent Reference 1 discloses, in a system which makes a portable terminal device and an on-vehicle device cooperate with each other to operate the application executed on the portable terminal device from the on-vehicle device, a technique of regulating the operation in accordance with the kind of the application being executed and the running state of the vehicle and regulating the display by turning the backlight off. By this technique, display and operation on the on-vehicle device is possible during the driving of the vehicle, if the smartphone is executing an application, such as a music reproduction application, which can be executed without a problem of safety during the driving.

On the other hand, when the smartphone and the on-vehicle device is connected with each other, it becomes necessary to use plural interfaces according to the specification of the smartphone. For example, there is such a case that the smartphone outputs the video/audio data (hereinafter referred to as “AV data”) via the HDMI (High Definition Multimedia Interface) and outputs control signals via a USB cable or Bluetooth (Registered Trademark). In this case, the smartphone and the on-vehicle device are connected with each other by two interfaces.

Here, it is assumed that one of those two interfaces is erroneously connected to another device. For example, it is assumed that the HDMI of the on-vehicle device is connected to a DVD player and Bluetooth is connected to the smartphone. Although the image of the music reproduction application is to be displayed in a normal connection, the image of the DVD player is displayed on the on-vehicle device in this case. At this time, naturally there occurs such a problem that the user cannot correctly operate the smartphone while watching the display of the on-vehicle device. In addition, if the user makes such a connection on purpose, the on-vehicle device cannot appropriately regulate the display during the driving and the image of the DVD player becomes visible, thereby causing a problem of safety.
Patent Reference 1: Japanese Patent Application Laid-Open under No. 2010-13670

### DISCLOSURE OF INVENTION

### Problem to be Solved by the Invention

The above is an example of the problems to be solved by the present invention. It is an object of the present invention to confirm that plural interfaces are connected to the same devices, when an information processing device is connected to an external device such as an on-vehicle device via the plural interfaces.

### Means for Solving the Problem

One invention is an information processing device communicable with an external device, comprising: a first connection means which performs a connection for communication with the external device; a second connection means which is different from the first connection means and which performs a connection for communication with the external device; a first communication unit which transmits a first specific identification information possessed by the information processing device to the external device via the first connection means; a second communication unit which receives a second specific identification information associated with the first specific identification information from the external device via the second connection means; and a determination unit which compares the second specific identification information received by the second connection means with a third specific identification information stored in the information processing device in advance, and determines whether or not the information processing device and the external device are in a simultaneous connection state in which the information processing device and the external device are connected by the first connection means and the second connection means.

Another invention is an information processing method executed by an information processing device communicable with an external device, comprising: a first communication process which performs a first communication with the external device via the first connection means, and transmits a first specific identification information possessed by the information processing device to the external device; a second communication process which performs a second communication with the external device via a second connection means different from the first connection means, and receives a second specific identification information associated with the first specific identification information from the external device; and a determination process which compares the second specific identification information received by the second communication process with a third specific identification information stored in the information processing device in advance, and determines whether or not the information processing device and the external device are in a simultaneous connection state in which the information processing device and the external device are connected by the first connection means and the second connection means.

Still another invention is an information processing program executed by an information processing device communicable with an external device, making the information processing device execute: a first communication process which performs a first communication with the external device via the first connection means, and transmits a first specific identification information possessed by the information processing device to the external device; a second communication process which performs a second communication with the external device via a second connection means different from the first connection means, and receives a second specific identification information associated with the first specific identification information from the external device; and a determination process which compares the second specific identification information received by the second communication process with a third specific identification information stored in the information processing device in advance, and determines whether or not the information processing device and the external device are in a simultaneous connection state in which the information processing device and the external device are connected by the first connection means and the second connection means.

Still another invention is an external device communicable with an information processing device, comprising: a first connection means which performs a connection for communication with the information processing device; a second connection means which is different from the first connection means and which performs a connection for communication with the information processing device; a third communication unit which performs a first communication with the information processing device via the first connection means, and receives a first specific identification information possessed by the information processing device; and a fourth communication unit which performs a second communication with the information processing device via the second connection means, and transmits a second specific identification information associated with the first specific identification information to the information processing device.

Still another invention is an external device communicable with an information processing device, comprising: a first connection means which performs a connection for communication with the information processing device; a second connection means which is different from the first connection means and which performs a connection for communication with the information processing device; a third communication unit which performs a first communication with the information processing device via the first connection means, and receives a first specific identification information possessed by the information processing device; a fourth communication unit which performs a second communication with the information processing device via the second connection means, and obtains a third specific identification information stored in the information processing device in advance; and a determination unit which compares the first specific identification information received by the third communication unit with the third specific identification information stored in advance and received by the fourth communication unit, and determines whether or not the information processing device and the external device are in a simultaneous connection state in which the information processing device and the external device are connected by the first connection means and the second connection means.

Still another invention is an information processing method executed by an external device communicable with an information processing device, comprising: a first communication process which performs a first communication with the information processing device via a first connection means, and receives a first specific identification information possessed by the information processing device; a second communication process which performs a second communication with the information processing device via a second connection means different from the first connection means, and obtains a third specific identification information stored in the information processing device in advance; and a determination process which compares the first specific identification information received by the first communication process with the third specific identification information stored in advance and received by the second communication process, and determines whether or not the information processing device and the external device are in a simultaneous connection state in which the information processing device and the external device are connected by the first connection means and the second connection means.

Still another invention is a server device communicable with an information processing device comprising: a receiving unit which transmits a first specific information possessed by the information processing device to an external device via a first connection means, and receives a second specific identification information associated with the first specific identification information received from the external device via a second connection means different from the first connection means; a storage unit which stores a third specific identification information in advance; and a determination unit which compares the second specific identification information received by the receiving unit with the third specific identification information stored in the storage unit in advance, and determines whether or not the information processing device and the external device are in a simultaneous connection state in which the information processing device and the external device are connected by the first connection means and the second connection means.

Still another invention is an information processing method executed by a server device communicable with an information processing device and including a storage unit which stores a third specific identification information in advance, the method comprising: a receiving process which transmits a first specific information possessed by the information processing device to an external device via a first connection means, and receives a second specific identification information associated with the first specific identification information and received from the external device via a second connection means different from the first connection means, from the information processing device; and a determination process which compares the second specific identification information received by the receiving process with the third specific identification information stored in the storage unit in advance, and determines whether or not the information processing device and the external device are in a simultaneous connection state in which the information processing device and the external device are connected by the first connection means and the second connection means.

Still another invention is a server device communicable with an information processing device comprising: a receiving unit which transmits a first specific information possessed by the information processing device to an external device via a first connection means, and receives a second specific identification information associated with the first specific identification information and received from the external device via a second connection means different from the first connection means and a third specific identification information stored in the information processing device in advance, from the information processing device; and a determination unit which compares the second specific identification information received by the receiving unit with the third specific identification information stored in the storage unit in advance, and determines whether or not the information processing device and the external device are in a simultaneous connection state in which the information processing device and the external device are connected by the first connection means and the second connection means.

### BRIEF DESCRIPTION OF THE DRAWINGS

FIG. 1 is a diagram illustrating a configuration of a system according to a first embodiment.

FIG. 2 is a flowchart of a connection authentication processing by the first embodiment.

FIG. 3 is a diagram illustrating a configuration of a system according to a second embodiment.

FIG. 4 is a flowchart of a connection authentication processing by the second embodiment.

FIG. 5 is a diagram illustrating a configuration of a system according to a third embodiment.

FIG. 6 is a flowchart of a connection authentication processing by the third embodiment.

FIG. 7 is a diagram illustrating a configuration of a system according to a fourth embodiment.

FIG. 8 is a flowchart of a connection authentication processing by the fourth embodiment.

FIG. 9 shows an example of an authentication image in simultaneous connection detection processing.

FIG. 10 is a flowchart of the simultaneous connection detection processing.

FIG. 11 shows another example of an authentication image in the simultaneous connection detection processing.

### DETAILED DESCRIPTION OF THE PREFERRED EMBODIMENTS

According to one aspect of the present invention, there is provided an information processing device communicable with an external device, comprising: a first connection means which performs a connection for communication with the external device; a second connection means which is different from the first connection means and which performs a connection for communication with the external device; a first communication unit which transmits a first specific identification information possessed by the information processing device to the external device via the first connection means; a second communication unit which receives a second specific identification information associated with the first specific identification information from the external device via the second connection means; and a determination unit which compares the second specific identification information received by the second connection means with a third specific identification information stored in the information processing device in advance, and determines whether or not the information processing device and the external device are in a simultaneous connection state in which the information processing device and the external device are connected by the first connection means and the second connection means.

The above information processing device connects with an external device by a first connection means and a second connection means different from each other. A first specific identification information possessed by the information processing device is transmitted from the information processing device to the external device via the first connection means, and additionally a second specific identification information associated with the first specific identification information is transmitted from the external device to the information processing device via the second connection means. The information processing device compares the second specific identification information received from the external device with the third specific identification information stored in advance, and determines whether or not the information processing device and the external device are in a simultaneous connection state in which the information processing device and the external device are connected by the first connection means and the second connection means.

In one mode of the above information processing device, the determination unit determines that the information processing device and the external device are in the simultaneous connection state when the second specific identification information coincides with the third specific identification information stored in the information processing device in advance.

Another mode of the above information processing device further comprises a simultaneous connection detection unit which transmits an authentication image to the external device by the first connection means, receives operation input information inputted by a user to the authentication image displayed on the external device, and performs a simultaneous connection detection for detecting that the information processing device and the external device are in the simultaneous connection state based on the operation input information, wherein the simultaneous connection detection unit executes the simultaneous connection detection when the determination unit determines that the information processing device and the external device are not in the simultaneous connection state. In this mode, when the simultaneous connection state cannot be determined based on the specific identification information, the simultaneous connection state is detected by the simultaneous connection detection by using the authentication image.

In a preferred example, the authentication image includes a touch area arranged at a random position; and the simultaneous connection detection unit obtains touch coordinates generated by the user's touch on the touch area in the authentication image displayed on the external device, and detects the simultaneous connection state based on the touch coordinates and a position of the touch area in the authentication image.

Another mode of the above information processing device further comprises an identification information storage unit which stores the second specific identification information, received by the second connection means when the simultaneous connection detection unit detects the simultaneous connection state, as the third specific identification information. Thus, the second specific identification information obtained in the simultaneous connection state can be stored as the third specific identification information and can be used in the determination next time.

In a preferred example, the first specific identification information may be formed by a combination of plural information specific to the information processing device.

According to another aspect of the present invention, there is provided an information processing method executed by an information processing device communicable with an external device, comprising: a first communication process which performs a first communication with the external device via the first connection means, and transmits a first specific identification information possessed by the information processing device to the external device; a second communication process which performs a second communication with the external device via a second connection means different from the first connection means, and receives a second specific identification information associated with the first specific identification information from the external device; and a determination process which compares the second specific identification information received by the second communication process with a third specific identification information stored in the information processing device in advance, and determines whether or not the information processing device and the external device are in a simultaneous connection state in which the information processing device and the external device are connected by the first connection means and the second connection means.

In still another aspect of the present invention, there is provided an information processing program executed by an information processing device communicable with an external device, making the information processing device execute: a first communication process which performs a first communication with the external device via the first connection means, and transmits a first specific identification information possessed by the information processing device to the external device; a second communication process which performs a second communication with the external device via a second connection means different from the first connection means, and receives a second specific identification information associated with the first specific identification information from the external device; and a determination process which compares the second specific identification information received by the second communication process with a third specific identification information stored in the information processing device in advance, and determines whether or not the information processing device and the external device are in a simultaneous connection state in which the information processing device and the external device are connected by the first connection means and the second connection means.

By the information processing method and the information processing program described above, it is possible to determine the simultaneous connection state of the external device and the information processing device. The above information processing program can be stored in a storage medium.

According to still another aspect of the present invention, there is provided an information processing system comprising an information processing device; an external device; a first connection means which performs a connection for communication between the information processing device and the external device; and a second connection means which is different from the first connection means and which performs a connection for communication between the information processing device and the external device. The information processing device includes a first communication unit which transmits a first specific identification information possessed by the information processing device to the external device via the first connection means; a second communication unit which receives a second specific identification information associated with the first specific identification information from the external device via the second connection means; and a determination unit which compares the second specific identification information received by the second connection means with a third specific identification information stored in the information processing device in advance, and determines whether or not the information processing device and the external device are in a simultaneous connection state in which the information processing device and the external device are connected by the first connection means and the second connection means. The external device includes a third communication unit which receives the first specific identification information from the information processing device via the first connection means; and a fourth communication unit which transmits the second specific identification information to the information processing device via the second connection means. By this system, it is possible to determine the simultaneous connection state of the external device and the information processing device.

According to still another aspect of the present invention, there is provided an external device communicable with an information processing device, comprising: a first connection means which performs a connection for communication with the information processing device; a second connection means which is different from the first connection means and which performs a connection for communication with the information processing device; a third communication unit which performs a first communication with the information processing device via the first connection means, and receives a first specific identification information possessed by the information processing device; and a fourth communication unit which performs a second communication with the information processing device via the second connection means, and transmits a second specific identification information associated with the first specific identification information to the information processing device. By this external device, it is possible to determine the simultaneous connection state of the external device and the information processing device.

One mode of the above external device further comprises: a display unit which displays an authentication image received by the first connection means; and a transmission unit which obtains an operation input information by a user, and transmits the operation input information to the information processing device by the fourth communication unit. In this mode, the simultaneous connection state can be detected based on the operation input to the authentication image.

According to still another aspect of the present invention, there is provided an external device communicable with an information processing device, comprising: a first connection means which performs a connection for communication with the information processing device; a second connection means which is different from the first connection means and which performs a connection for communication with the information processing device; a third communication unit which performs a first communication with the information processing device via the first connection means, and receives a first specific identification information possessed by the information processing device; a fourth communication unit which performs a second communication with the information processing device via the second connection means, and obtains a third specific identification information stored in the information processing device in advance; and a determination unit which compares the first specific identification information received by the third communication unit with the third specific identification information stored in advance and received by the fourth communication unit, and determines whether or not the information processing device and the external device are in a simultaneous connection state in which the information processing device and the external device are connected by the first connection means and the second connection means.

The above external device is connected with the information processing device by the first connection means and the second connection means different from each other. The first specific identification information possessed by the information processing device is transmitted from the information processing device to the external device via the first connection means, and additionally the third specific identification information stored in the processing device in advance is transmitted from the information processing device to the external device via the second connection means. The external device compares the first specific identification information received by the first connection means with the third specific identification information stored in advance and received by the second connection means, and determines whether or not the information processing device and the external device are in the simultaneous connection state in which the information processing device and the external device are connected by the first connection means and the second connection means.

In still another aspect of the present invention, there is provided an information processing method executed by an external device communicable with an information processing device, comprising: a first communication process which performs a first communication with the information processing device via a first connection means, and receives a first specific identification information possessed by the information processing device; a second communication process which performs a second communication with the information processing device via a second connection means different from the first connection means, and obtains a third specific identification information stored in the information processing device in advance; and a determination process which compares the first specific identification information received by the first communication process with the third specific identification information stored in advance and received by the second communication process, and determines whether or not the information processing device and the external device are in a simultaneous connection state in which the information processing device and the external device are connected by the first connection means and the second connection means.

According to still another aspect of the present invention, there is provided an information processing program executed by an external device communicable with an information processing device, making the external device execute: a first communication process which performs a first communication with the information processing device via a first connection means, and receives a first specific identification information possessed by the information processing device; a second communication process which performs a second communication with the information processing device via a second connection means different from the first connection means, and obtains a third specific identification information stored in the information processing device in advance; and a determination process which compares the first specific identification information received by the first communication process with the third specific identification information stored in advance and received by the second communication process, and determines whether or not the information processing device and the external device are in a simultaneous connection state in which the information processing device and the external device are connected by the first connection means and the second connection means.

By the information processing method and the information processing program described above, it is possible to determine the simultaneous connection state of the external device and the information processing device. The above information processing program may be stored in a storage medium.

According to still another aspect of the present invention, there is provided an information processing system comprising an information processing device; an external device; a first connection means which performs a connection for communication between the information processing device and the external device; and a second connection means which is different from the first connection means and which performs a connection for communication between the information processing device and the external device. The information processing device includes a first communication unit which performs a first communication with the external device via the first connection means, and transmits the first specific identification information possessed by the information processing device to the external device; and a second communication unit which performs a second communication with the external device via the second connection means, and transmits a third specific identification information stored in the information processing device in advance to the external device. The external device includes a third communication unit which performs the first communication with the information processing device via the first connection means, and receives the first specific identification information from the information processing device; a fourth communication unit which performs the second communication with the information processing device via the second connection means, and obtains the third specific identification information stored in the information processing device in advance; and a determination unit which compares the first specific identification information received by the third communication unit with the third specific identification information stored in advance and received by the fourth communication unit, and determines whether or not the information processing device and the external device are in a simultaneous connection state in which the information processing device and the external device are connected by the first connection means and the second connection means. By this system, it is possible to determine the simultaneous connection state of the external device and the information processing device.

According to still another aspect of the present invention, there is provided a server device communicable with an information processing device comprising: a receiving unit which transmits a first specific information possessed by the information processing device to an external device via a first connection means, and receives a second specific identification information associated with the first specific identification information received from the external device via a second connection means different from the first connection means; a storage unit which stores a third specific identification information in advance; and a determination unit which compares the second specific identification information received by the receiving unit with the third specific identification information stored in the storage unit in advance, and determines whether or not the information processing device and the external device are in a simultaneous connection state in which the information processing device and the external device are connected by the first connection means and the second connection means.

The first specific identification information possessed by the information processing device is transmitted to the external device via the first connection means. The server device receives the second specific identification information, associated with the first specific identification information and transmitted from the external device to the information processing device via the second connection means, from the information processing device, and compares it with the third specific identification information stored in the server device. Thus, the server device determines whether or not the information processing device and the external device are in the simultaneous connection state in which they are connected by the first connection means and the second connection means.

One mode of the above server device further comprises a storage unit which requests, to the information processing device, a detection of whether or not the information processing device and the external device are in the simultaneous connection state when the determination unit determines that the information processing device and the external device are not in the simultaneous connection state, and receives the second specific identification information at the time when the information processing device detects the simultaneous connection state from the information processing device, and stores the received second specific identification information into the storage unit as the third specific identification information. By this, the server device can store the specific identification information in the simultaneous connection state.

One mode of the above server device further comprises a notification unit which notifies a determination result to the information processing device when the determination unit determines that the information processing device and the external device are in the simultaneous connection state. By notifying the determination result to the external device via the information processing device, it is possible to notify the simultaneous connection state to the external device.

According to still another aspect of the present invention, there is provided an information processing method executed by a server device communicable with an information processing device and including a storage unit which stores a third specific identification information in advance, the method comprising: a receiving process which transmits a first specific information possessed by the information processing device to an external device via a first connection means, and receives a second specific identification information associated with the first specific identification information and received from the external device via a second connection means different from the first connection means, from the information processing device; and a determination process which compares the second specific identification information received by the receiving process with the third specific identification information stored in the storage unit in advance, and determines whether or not the information processing device and the external device are in a simultaneous connection state in which the information processing device and the external device are connected by the first connection means and the second connection means.

According to still another aspect of the present invention, there is provided an information processing program executed by a server device communicable with an information processing device and including a storage unit which stores a third specific identification information in advance, the program making the server device execute: a receiving process which transmits a first specific information possessed by the information processing device to an external device via a first connection means, and receives a second specific identification information associated with the first specific identification information and received from the external device via a second connection means different from the first connection means, from the information processing device; and a determination process which compares the second specific identification information received by the receiving process with the third specific identification information stored in the storage unit in advance, and determines whether or not the information processing device and the external device are in a simultaneous connection state in which the information processing device and the external device are connected by the first connection means and the second connection means.

By the information processing method and the information processing program described above, it is possible to determine the simultaneous connection state of the external device and the information processing device. The above information processing program may be stored in a storage medium.

According to still another aspect of the present invention, there is provided an information processing system comprising an information processing device; an external device; a first connection means which performs a connection for communication between the information processing device and the external device; a second connection means which is different from the first connection means and which performs a connection for communication between the information processing device and the external device; and a server device. The information processing device includes a first communication unit which transmits a first specific identification information possessed by the information processing device to the external device via the first connection means; a second communication unit which receives a second specific identification information associated with the first specific identification information by the second connection means; and a transmission unit which transmits the second specific identification information received by the second communication unit to the server device. The external device includes a third communication unit which receives the first specific identification information possessed by the information processing device via the first connection means; and a fourth communication unit which transmits the second specific identification information associated with the first specific identification information to the information processing device via the second connection means. The server device includes a receiving unit which receives the second specific identification information from the information processing device; a storage unit which stores a third specific identification information in advance; and a determination unit which compares the second specific identification information received by the receiving unit with the third specific identification information stored in the storage unit in advance, and determines whether or not the information processing device and the external device are in a simultaneous connection state in which the information processing device and the external device are connected by the first connection means and the second connection means. By this system, it is possible to determine the simultaneous connection state of the external device and the information processing device.

According to still another aspect of the present invention, there is provided a server device communicable with an information processing device comprising: a receiving unit which transmits a first specific information possessed by the information processing device to an external device via a first connection means, and receives a second specific identification information associated with the first specific identification information and received from the external device via a second connection means different from the first connection means and a third specific identification information stored in the information processing device in advance, from the information processing device; and a determination unit which compares the second specific identification information received by the receiving unit with the third specific identification information stored in the storage unit in advance, and determines whether or not the information processing device and the external device are in a simultaneous connection state in which the information processing device and the external device are connected by the first connection means and the second connection means.

In the above server device, the first specific identification information possessed by the information processing device is transmitted from the information processing device to the external device via the first connection means. The server device receives the second specific identification information, associated with the first specific identification information and transmitted from the external device to the information processing device via the second connection means, from the information processing device, receives the third specific identification information stored in the information processing device in advance, and compare them with each other. Thus, the server device determines whether or not the information processing device and the external device are in a simultaneous connection state in which they are connected by the first connection means and the second connection means.

One mode of the above server device further comprising a notification unit which notifies a determination result to the information processing device when the determination unit determines that the information processing device and the external device are in the simultaneous connection state. By notifying the determination result to the external device via the information processing device, it is possible to notify the simultaneous connection state to the external device.

According to still another aspect of the present invention, there is provided an information processing method executed by a server device communicable with an information processing device, the method comprising: a receiving process which transmits a first specific information possessed by the information processing device to an external device via a first connection means, and receives a second specific identification information associated with the first specific identification information and received from the external device via a second connection means different from the first connection means and a third specific identification information stored in the information processing device in advance, from the information processing device; and a determination process which compares the second specific identification information received by the receiving process with the third specific identification information stored in the storage unit in advance, and determines whether or not the information processing device and the external device are in a simultaneous connection state in which the information processing device and the external device are connected by the first connection means and the second connection means.

According to still another aspect of the present invention, there is provided an information an information processing program executed by a server device communicable with an information processing device, the program making the server device execute: a receiving process which transmits a first specific information possessed by the information processing device to an external device via a first connection means, and receives a second specific identification information associated with the first specific identification information and received from the external device via a second connection means different from the first connection means and a third specific identification information stored in the information processing device in advance, from the information processing device; and a determination process which compares the second specific identification information received by the receiving process with the third specific identification information stored in the storage unit in advance, and determines whether or not the information processing device and the external device are in a simultaneous connection state in which the information processing device and the external device are connected by the first connection means and the second connection means.

By the information processing method and the information processing program described above, it is possible to determine the simultaneous connection state of the external device and the information processing device. The above information processing program may be stored in a storage medium.

According to still another aspect of the present invention, there is provided an information processing system comprising an information processing device; an external device; a first connection means which performs a connection for communication between the information processing device and the external device; a second connection means which is different from the first connection means and which performs a connection for communication between the information processing device and the external device; and a server device. The information processing device includes a first communication unit which transmits a first specific identification information possessed by the information processing device to the external device via the first connection means; a second communication unit which receives a second specific identification information associated with the first specific identification information by the second connection means; and a transmission unit which transmits a third specific identification information stored in the information processing device in advance and the second specific identification information received by the second communication unit to the server device. The external device includes a third communication unit which receives the first specific identification information possessed by the information processing device via the first connection means; and a fourth communication unit which transmits the second specific identification information associated with the first specific identification information to the information processing device via the second connection means. The server device includes a receiving unit which receives the second specific identification information that the information processing device receives from the external device via the second connection means and the third specific identification information stored in the information processing device in advance, from the information processing device; and a determination unit which compares the second specific identification information received by the receiving unit with the third specific identification information, and determines whether or not the information processing device and the external device are in a simultaneous connection state in which the information processing device and the external device are connected by the first connection means and the second connection means. By this system, it is possible to determine the simultaneous connection state of the external device and the information processing device.

### EMBODIMENTS

Preferred embodiments of the present invention will be described below with reference to the attached drawings.

### 1st Embodiment

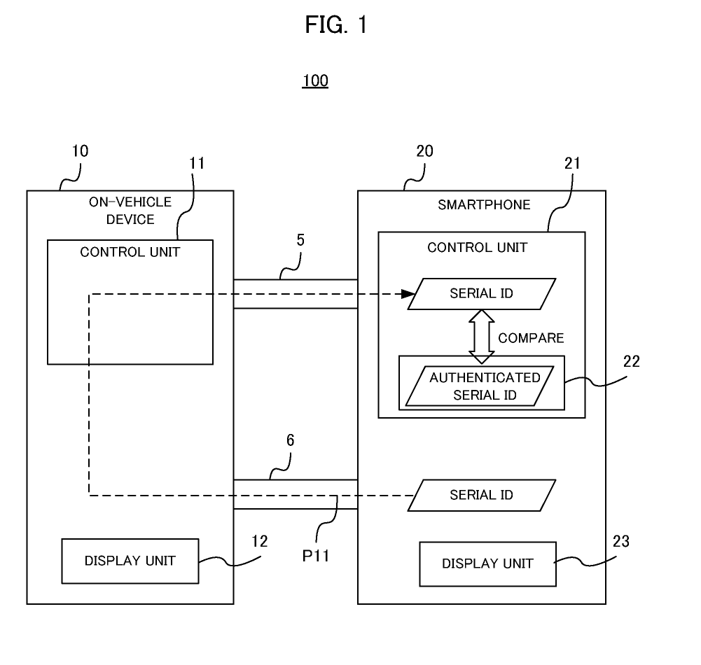

FIG. 1 illustrates a configuration of a system according to a first embodiment of the present invention. The system 100 includes an on-vehicle device 10 serving as an external device and a smartphone 20 serving as an information processing device. A typical example of the on-vehicle device 10 is a navigation device. The on-vehicle device 10 and the smartphone 20 are connected with each other by two interfaces, i.e., via a SPP (Serial Port Profile) 5 and a HDMI 6. The SPP 5 is mainly used for the communication of control signals between the on-vehicle device 10 and the smartphone 20, and the HDMI 6 is mainly used for the transmission of AV data from the smartphone 20 to the on-vehicle device 10. The HDMI 6 and SPP 5 correspond to a first connection means and a second connection means of the present invention, respectively.

The on-vehicle device 10 includes a control unit 11 and a display unit 12. The control unit 11 includes a CPU, a ROM and a RAM, and executes programs prepared in advance to control the on-vehicle device 10. The display unit 12 is a liquid crystal display, for example, and displays the images generated in the on-vehicle device 10 and the images transmitted from the smartphone 20 via the HDMI 6.

The smartphone 20 includes a control unit 21 and a display unit 23. The control unit 21 includes a CPU, a ROM and a RAM, and executes programs prepared in advance to control the smartphone 20. In addition, the control unit 21 includes a storage unit 22. The storage unit 22 stores an authenticated serial ID described later. The display unit 23 is a liquid crystal display, for example, and displays various images generated in the smartphone 20.

In this embodiment, the smartphone 20 generates a serial ID which is identification information specific to the smartphone 20. By using the serial ID, the smartphone 20 determines whether or not the on-vehicle device 10 and the smartphone 20 are connected with each other by two interfaces, i.e., the SPP 5 and the HDMI 6. In other words, the smartphone 20 determines whether or not the two interfaces, i.e., the SPP 5 and the HDMI 6 connected to the on-vehicle device 10 are connected to the same smartphone 20. Such a state that the on-vehicle device 10 and the smartphone 20 are connected with each other by the SPP 5 and the HDMI 6 will be hereinafter referred to as “a simultaneous connection state”. As described above, in a case where plural interfaces are connected to the on-vehicle device, if the on-vehicle device and the smartphone are not in the simultaneous connection state, the image displayed on the on-vehicle device becomes different and the smartphone controllable by the on-vehicle device becomes different. Therefore, the user cannot correctly operate the smartphone while watching the display on the on-vehicle device, and the on-vehicle device cannot appropriately inhibit the display of the image during the driving of the vehicle. In this view, in this embodiment, the serial ID is used to determine whether or not the on-vehicle device 10 and the smartphone 20 are in the simultaneous connection state. This determination processing will be hereinafter referred to as “connection authentication processing”.

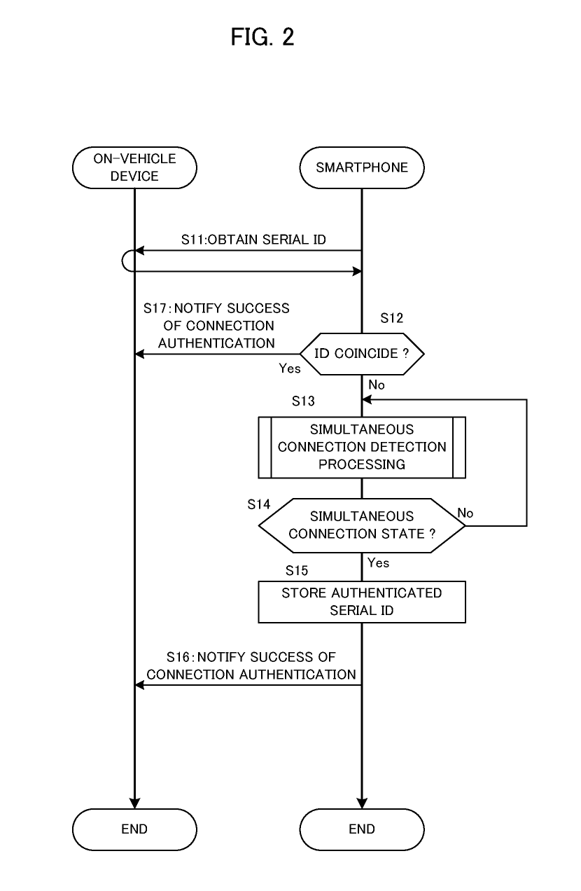

FIG. 2 is a flowchart of connection authentication processing according to this embodiment. In the connection authentication processing according to this embodiment, the smartphone 20 determines that the on-vehicle device 10 and the smartphone 20 are connected by the SPP 5 and the HDMI 6 as shown in FIG. 1. This processing is executed when the on-vehicle device 10 and the smartphone 20 are connected by plural interfaces.

Specifically, the smartphone 20 transmits its own serial ID to the on-vehicle device 10 via the HDMI 6 as indicated by the path P11 of the broken line in FIG. 1. The serial ID thus transmitted via the HDMI 6 corresponds to the first specific identification information of the present invention. Further, the smartphone 20 receives the serial ID from the on-vehicle device 10 via the SPP 5 (step S11). The serial ID thus received via the SPP 5 corresponds to the second specific identification information of the present invention.

Next, the control unit 21 of the smartphone 20 compares the serial ID received from the on-vehicle device 10 via the path P11 with the authenticated serial ID stored in advance in the storage unit 22 (step S12). This authenticated serial ID corresponds to the third specific identification information of the present invention.

When they do not coincide (step S12: No), it means that the simultaneous connection state is not confirmed, and simultaneous connection detection processing is executed (step S13). The simultaneous connection detection processing is to transmit a predetermined authentication image from the smartphone 20 to the on-vehicle device 10 to display it on the on-vehicle device 10 and detect that the on-vehicle device 10 and the smartphone 20 are in the simultaneous connection state based on the user's input to the displayed image. The detail of the simultaneous connection detection processing will be described later.

The simultaneous connection detection processing is basically repeated until the simultaneous connection state is detected. When the simultaneous connection state is detected (step S14: Yes), the control unit 21 stores the serial ID at that time into the storage unit 22 as the authenticated serial ID (step S15), and notifies the on-vehicle device 10 of the success of the connection authentication (step S16).

On the other hand, when the serial ID and the authenticated serial ID coincide with each other in step S12 (step S12: Yes), the control unit 21 determines that the on-vehicle device 10 and the smartphone 20 are in the simultaneous connection state, and notifies the on-vehicle device 10 of the success of the connection authentication (step S17).

As described above, the authenticated serial ID stored in the storage unit 22 is the serial ID obtained at the time when the simultaneous connection detection processing was executed and the simultaneous connection state was established in the past. Therefore, the fact that serial ID and the authenticated serial ID coincide with each other in step S12 means that the serial ID transmitted from the smartphone 20 to the on-vehicle device 10 via the HDMI 6 returns from the on-vehicle device 10 via the SPP 5, and this means that the on-vehicle device 10 and the smartphone 20 are connected by the SPP 5 and the HDMI 6. When the simultaneous connection state is determined by the comparison with the authenticated serial ID, the control unit 21 determines that the connection authentication is successful, and ends the connection authentication processing.

In this way, when determining that the on-vehicle device 10 and the smartphone 20 are in the simultaneous connection state, the smartphone 20 transmits the notification of the successful connection authentication to the on-vehicle device 10. When receiving the notification of the successful connection authentication, the on-vehicle device 10 can control the operation of the smartphone 20 by transmitting the control signals to the smartphone 20 via the SPP 5. Namely, the on-vehicle device 10 can receive the image from the smartphone 20 via the HDMI 6 and control the smartphone 20 via the SPP 5. Therefore, the user can correctly operate the smartphone 20 while watching the display image of the smartphone 20 that is displayed on the on-vehicle device 10. In addition, in the case where the application being executed on the smartphone 20 and displayed on the on-vehicle device 10 during the driving of the vehicle is not the application, such as the music reproduction application, that can be used without causing the problem of the safety during the driving of the vehicle, the on-vehicle device 10 may regulate the display of the image or operation of the application from the on-vehicle device 10.

As understood from the above description, when the on-vehicle device 10 and a certain smartphone 20 are simultaneously connected for the first time, naturally the serial ID of the smartphone 20 is not stored yet in the storage unit 22 of the smartphone 20. Therefore, at the time of the first connection, the determination in step S12 results in “No”, and the simultaneous connection state of the on-vehicle device 10 and the smartphone 20 is detected by the simultaneous connection detection processing in step S13. When the simultaneous connection state is detected by the simultaneous connection detection processing, the serial ID at that time is stored in the storage unit 22 as the authenticated serial ID. Therefore, when the smartphone 20 is correctly connected to the on-vehicle device 10 by the SPP 5 and the HDMI 6 next time and thereafter, the serial ID and the authenticated serial ID coincide with each other in step S12, and the determination of the simultaneous connection state, i.e., the connection authentication can be performed without executing the simultaneous connection detection processing once again. Of course, as the authenticated serial ID, the serial ID of the smartphone 20 may be stored from the beginning. In that case, the connection authentication can be performed from the beginning without executing the simultaneous connection detection processing.

Next, the serial ID will be described. The serial ID is identification information specific to the smartphone 20, and is determined uniquely to each of the smartphone 20. Specifically, the serial ID may be a serial number of the smartphone, a device name of the smartphone, SPD (Source Product Description) Info frame data of the HDMI installed in the smartphone, or HDCP (High-bandwidth Digital Content Protection system) authentication data. Further, the serial ID may be a combination of those plural information. If one of the above information is used alone as the serial ID, the serial IDs of plural smartphone may coincide for some reason. In this respect, if the combination of those plural information is used as the serial ID, the possibility that the serial IDs of the plural smartphones coincide may be reduced.

In the above embodiment, the on-vehicle device 10 transmits the serial ID received from the smartphone 20 to the smartphone 20 as it is via the SPP 5. Instead, the on-vehicle device 10 may apply a predetermined processing, e.g., encryption or compression, to the serial ID received from the smartphone 20 and then transmit it to the smartphone 20. In that case, the smartphone 20 receives the serial ID thus processed, applies the decryption or decompression to generate the original serial ID and then compares it with the authenticated serial ID.

Further, the on-vehicle device 10 may add identification information specific to the on-vehicle device 10 to the serial ID received via the HDMI 6. Namely, the serial ID transmitted via the SPP 5 is different from the serial ID received from the HDMI 6, but is a serial ID associated with the serial ID of the smartphone 20. In that case, the smartphone 20 receives the serial ID after the additional processing to compare it with the authenticated serial ID, and determines that the on-vehicle device 10 and the smartphone 20 are in the simultaneous connection state when those serial ID coincide.

While the authenticated serial ID is stored in the storage unit 22 of the smartphone 20 in the above embodiment, the authenticated serial ID may be stored in a server (not shown) communicable with the smartphone 20 instead. In that case, the smartphone 20 receives the authenticated serial ID from the server via communication to determine the simultaneous connection state. When the simultaneous connection state is detected by the simultaneous connection detection processing, the serial ID at that time is stored in the server as the authenticated serial ID. In the configuration to store the authenticated serial ID in the server, the connection authentication processing can be executed next time even if the smartphone 20 is initialized or reset.

### 2nd Embodiment

Next, a second embodiment of the present invention will be described. While the smartphone 20 mainly executes the connection authentication processing in the first embodiment, the on-vehicle device 10 mainly executes the connection authentication processing in the second embodiment. It is noted that the authenticated serial ID is stored in the smartphone 20.

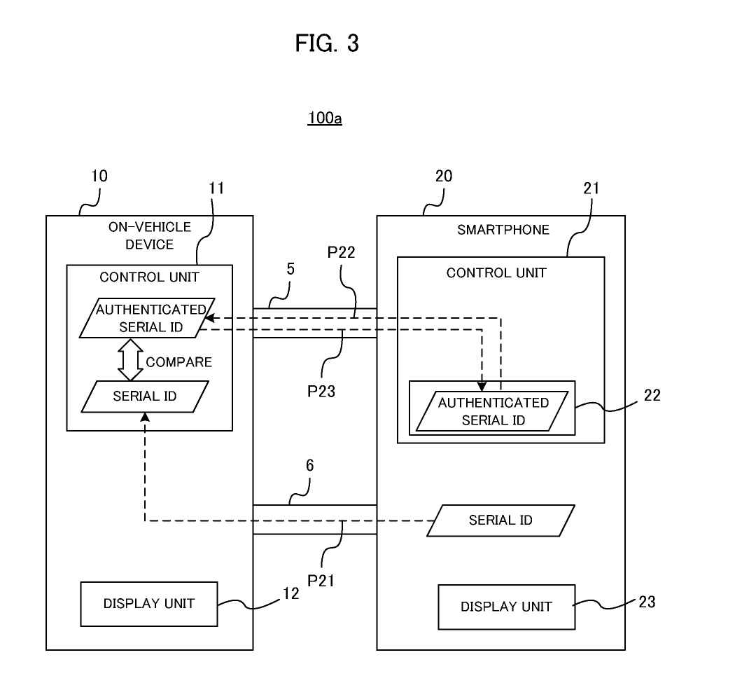

FIG. 3 illustrates the configuration of the system 100a according to the second embodiment. As is understood by comparing with FIG. 1, the configuration of the on-vehicle device 10 and the smartphone 20 is basically the same as those in the first embodiment. However, in the connection authentication processing, the control unit 11 of the on-vehicle device 10 obtains the authenticated serial ID from the storage unit 22 of the smartphone 20 to compare the serial IDs.

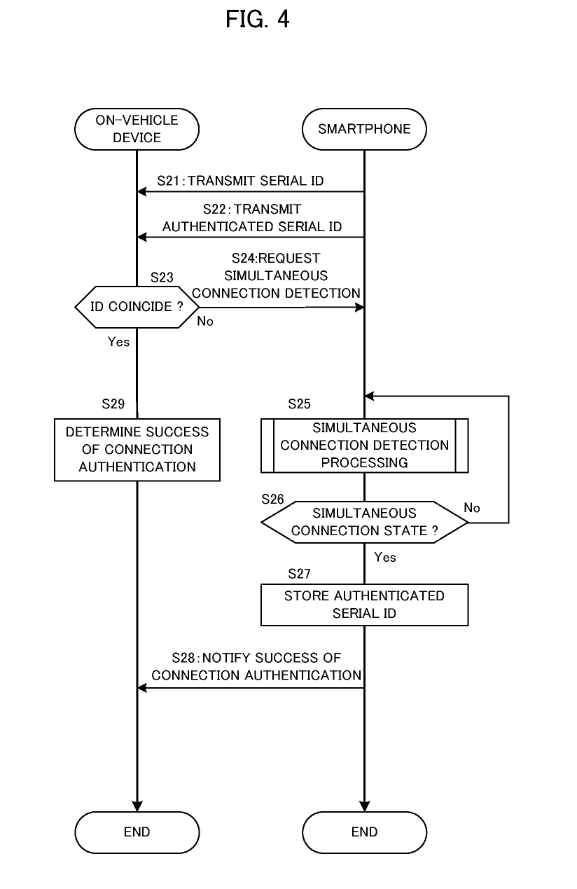

FIG. 4 is a flowchart of the connection authentication processing in the second embodiment. In the connection authentication processing in this embodiment, the on-vehicle device 10 determines that the on-vehicle device 10 and the smartphone 20 are simultaneously connected with each other by the SPP 5 and the HDMI 6. This processing is executed when the on-vehicle device 10 and the smartphone 20 are connected with each other by plural interfaces.

Specifically, first the on-vehicle device 10 receives the serial ID from the smartphone 20 via the HDMI 6 as indicated by the path P21 of the broken line (step S21). Next, the on-vehicle device 10 receives the authenticated serial ID from the smartphone 20 via the SPP 5 as indicated by the path P22 of the broken line (step S22). Then, the control unit 11 of the on-vehicle device 10 compares the serial ID and the authenticated serial ID thus received (step S23).

When the serial IDs do not coincide (step S23: No), it means that the simultaneous connection state is not confirmed, and the on-vehicle device 10 requests the simultaneous connection detection to the smartphone 20 (step S24).

In response, the smartphone 20 executes the simultaneous connection detection processing (step S25). Basically, the simultaneous connection detection processing is repeated until the simultaneous connection state is detected. When the simultaneous connection state is detected (step S26: Yes), the control unit 21 of the smartphone 20 stores the serial ID at that time into the storage unit 22 as the authenticated serial ID (step S27), and notifies the on-vehicle device 10 that the simultaneous connection state is detected, i.e., the connection authentication succeeded (step S28). Thus, the on-vehicle device 10 can confirm the simultaneous connection state.

On the other hand, when the serial ID and the authenticated serial ID coincide with each other in step S23 (step S23: Yes), the on-vehicle device 10 determines that the connection authentication succeeded (step S29), and ends the processing.

As described above, in the second embodiment, the on-vehicle device 10 executes the connection authentication by using the serial ID specific to the smartphone 20. Then, when the connection authentication succeeded, the on-vehicle device 10 controls the smartphone 20 to inhibit the output of the images during the driving of the vehicle, as necessary.

Also in the above embodiment, when the serial ID and the authenticated serial ID are transmitted and received between the on-vehicle device 10 and the smartphone 20 via the SPP 5, predetermined processing such as encryption or compression may be applied to those data and the on-vehicle device 10 may add specific identification information to those data.

While the authenticated serial ID is stored in the storage unit 22 of the smartphone 20 in the above embodiment, the authenticated serial ID may be stored in a server (not shown) communicable with the smartphone 20 instead. In this case, the on-vehicle device 10 receives the authenticated serial ID from the server via the smartphone 20 to determine the simultaneous connection state. When the simultaneous connection state is detected by the simultaneous connection detection processing, the serial ID at that time is stored in the server as the authenticated serial ID. In such a configuration that the authenticated serial ID is stored in the server, the connection authentication processing can be performed next time, even if the smartphone 20 is initialized or reset.

### 3rd Embodiment

Next, a third embodiment of the present invention will be described. In the third embodiment, a server communicable with the smartphone 20 mainly executes the connection authentication processing. The authenticated serial ID is stored in the server.

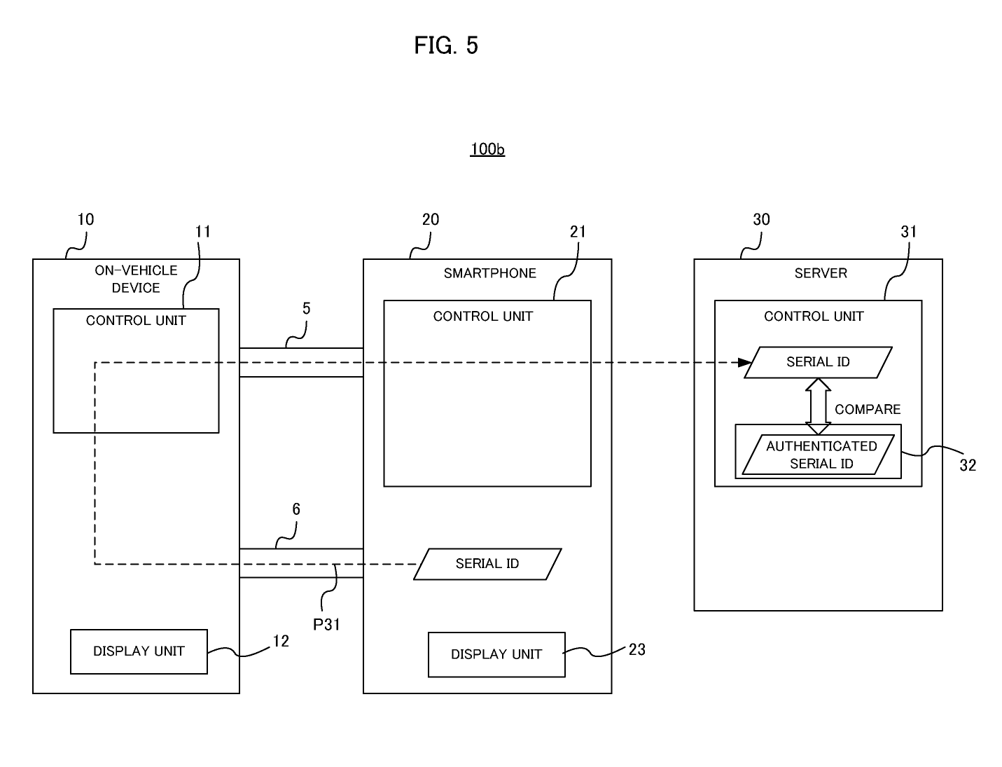

FIG. 5 illustrates a configuration of the system 100b according to the third embodiment. The configuration of the on-vehicle device 10 is the same as that of the first embodiment shown in FIG. 1. The configuration of the smartphone 20 is basically the same as that of the first embodiment except for that it does not have the storage unit 22 for storing the authenticated serial ID.

Additionally, the system 100b includes a server 30. The server 30 has a role of executing the connection authentication processing, and includes a control unit 31 and a storage unit 32. The control unit 31 includes a CPU, a ROM and a RAM, and executes the connection authentication processing by executing the program prepared in advance. The control unit 31 includes the storage unit 32 which stores the authenticated serial ID.

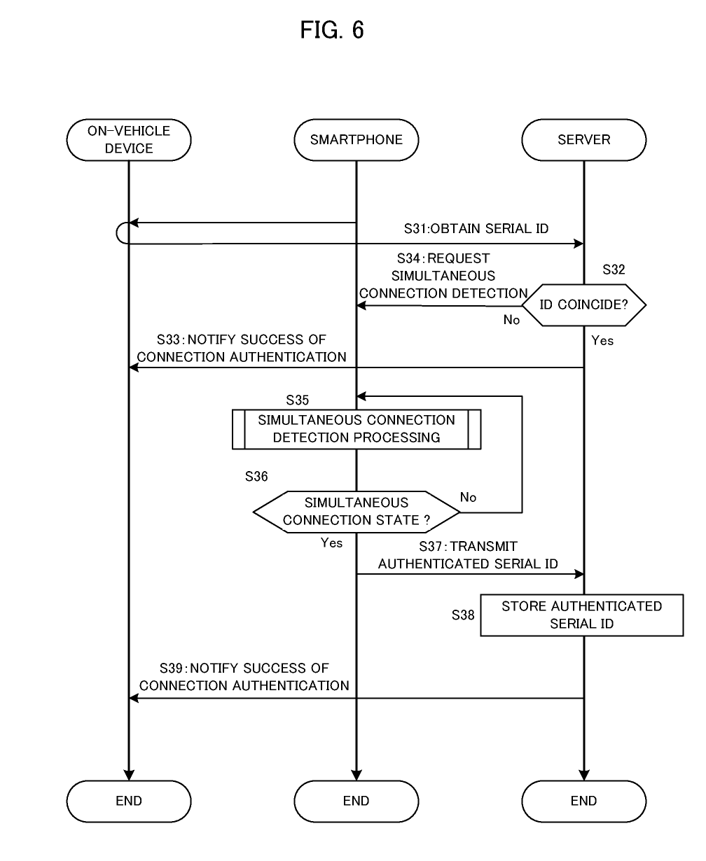

FIG. 6 is a flowchart showing the connection authentication processing according to the third embodiment. In the connection authentication processing of this embodiment, the server 30 determines that the on-vehicle device 10 and the smartphone 20 are simultaneously connected with each other by the SPP 5 and the HDMI 6. This processing is executed when the on-vehicle device 10 and the smartphone 20 are connected via plural interfaces.

Specifically, the smartphone 20 first transmits the serial ID to the on-vehicle device 10 via the HDMI 6 and the on-vehicle device 10 transmits the serial ID to the smartphone 20 via the SPP 5, as shown by the path P31 of the broken line. Then, the smartphone 20 receives the serial ID, and transmits it to the server 30 (step S31).

Next, the control unit 31 of the server 30 compares the serial ID received from the smartphone 20 with the authenticated serial ID stored in the storage unit 32 (step S32). When those serial IDs coincide with each other (step S32: Yes), the server 30 determines that the connection authentication succeeded, and notifies it to the on-vehicle device 10 (step S33). In this case, the server 30 may notify the success of the connection authentication to the smartphone 20 and the smartphone 20 may further notify it to the on-vehicle device 10.

On the other hand, when the serial IDs do not coincide with each other (step S32: No), it means that the simultaneous connection state is not confirmed, and the server 30 requests the simultaneous connection detection to the smartphone 20 (step S34).

In response, the smartphone 20 executes the simultaneous connection detection processing (step S35). The simultaneous connection detection processing is basically repeated until the simultaneous connection state is detected. When the simultaneous connection state is detected (step S36: Yes), the control unit 21 of the smartphone 20 transmits the serial ID at that time to the server 30 (step S37), and the server 30 receives the serial ID and stores it in the storage unit 32 as the authenticated serial ID (step S38). Then, the server 30 notifies the on-vehicle 10 of the success of the connection authentication (step S39). Also in this case, the server 30 may notify the success of the connection authentication to the smartphone 20, and the smartphone 20 may further notify it to the on-vehicle device 10. Thus, the on-vehicle device 10 can confirm the simultaneous connection state, and the connection authentication processing ends.

As described above, in the third embodiment, the server 30 executes the connection authentication processing by using the serial ID specific to the smartphone 20. If the connection authentication succeeds, the server 30 notifies the success to the on-vehicle device 10. Thereafter, operating the smartphone 20 from the on-vehicle device 10 becomes possible, and the images of the smartphone 20 can be displayed on the display unit of the on-vehicle device 10. Therefore, the user can correctly operate the smartphone 20 while watching the image of the smartphone 20 displayed on the on-vehicle device 10. In addition, in the case where the application being executed on the smartphone 20 and displayed on the on-vehicle device 10 during the driving of the vehicle is not the application, such as the music reproduction application, that can be used without causing the problem of the safety during the driving of the vehicle, the on-vehicle device 10 may regulate the display of the image or operation of the application from the on-vehicle device 10.

Also in this embodiment, predetermined processing such as encryption, compression and/or addition of specific identification information may be applied to the serial ID when the on-vehicle device 10 and the smartphone 20 transmit and receive the serial ID via the SPP 5 and when the smartphone 20 transmits the serial ID to the server 30.

### 4th Embodiment

Next, a fourth embodiment of the present invention will be described. In the fourth embodiment, a server communicable with the smartphone 20 mainly executes the connection authentication processing. The authenticated serial ID is stored in the smartphone 20.

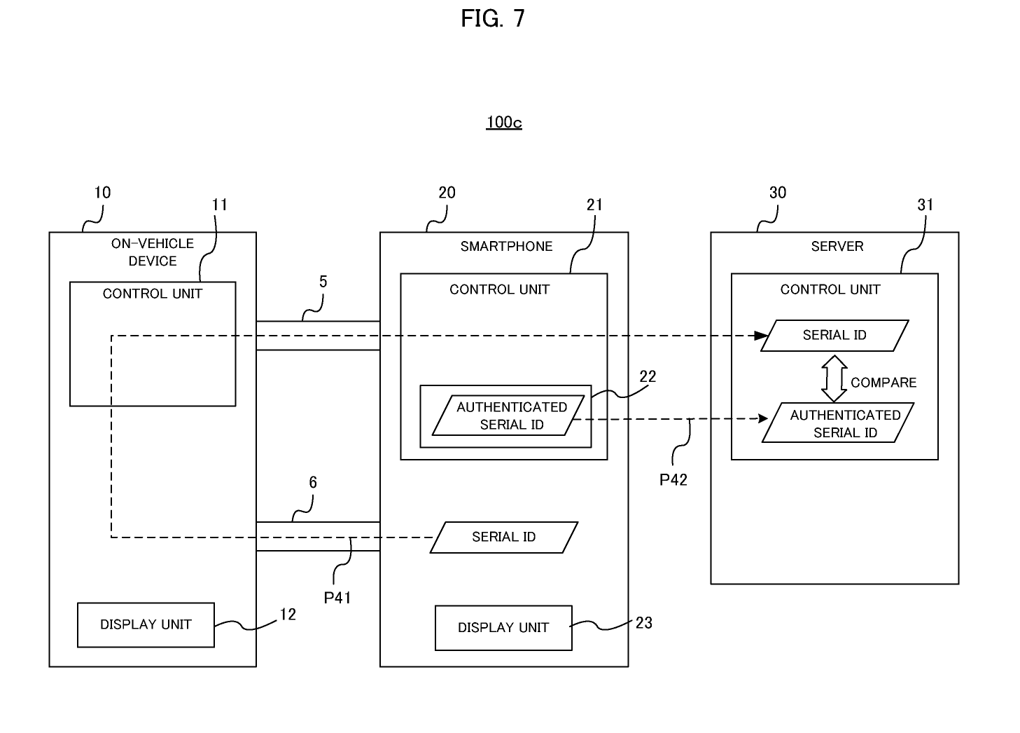

FIG. 7 illustrates a configuration of the system 100c according to the fourth embodiment. The configuration of the system 100c is the same as the system 100b of the third embodiment except for that the storage unit for storing the authenticated serial ID is provided not in the server 30 but in the smartphone 20. Namely, the smartphone 20 includes a storage unit 22 for storing the authenticated serial ID.

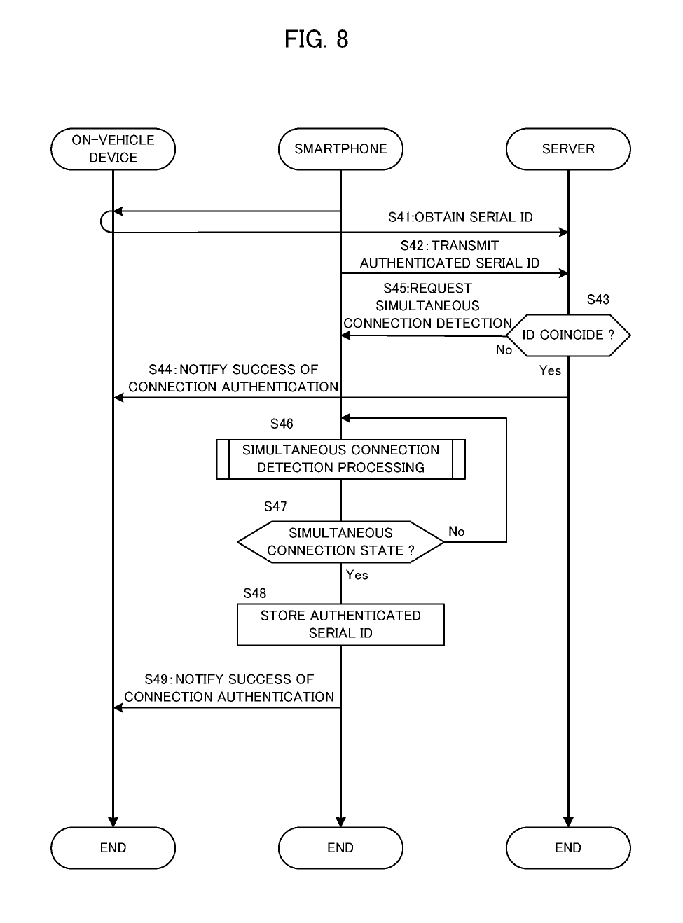

FIG. 8 is a flowchart showing the connection authentication processing according to the fourth embodiment. In the connection authentication processing in this embodiment, the server 30 determines that the on-vehicle device 10 and the smartphone 20 are simultaneously connected with each other by the SPP 5 and the HDMI 6. This processing is executed when the on-vehicle device 10 and the smartphone 20 are connected with each other by plural interfaces.

Specifically, the smartphone 20 first transmits the serial ID to the on-vehicle device 10 via the HDMI 6 and the on-vehicle device 10 transmits it to the smartphone 20 via the SPP 5, as indicated by the path P41 of the broken line. Then, the smartphone 20 receives the serial ID, and transmits it to the server 30 (step S41). Also, the server 30 receives the authenticated serial ID stored in the storage unit 22 of the smartphone 20 from the smartphone 20 (step S42).

Next, the server 30 compares the serial ID and the authenticated serial ID received from the smartphone 20 (step S43). When the serial IDs coincide with each other (step S43: Yes), the server 30 determines that the connection authentication succeeded, and notifies the success to the on-vehicle device 10 (step S44). In this case, the server 30 may notifies the success to the smartphone 20, and the smartphone 20 may further notifies it to the on-vehicle device 10.

On the other hand, when the serial IDs do not coincide with each other (step S43: No), it means that the simultaneous connection state is not confirmed, and the server 30 requests the simultaneous connection detection to the smartphone 20 (step S45).

In response, the smartphone 20 executes the simultaneous connection detection processing (step S46). The simultaneous connection detection processing is basically repeated until the simultaneous connection state is detected. When the simultaneous connection state is detected (step S46: Yes), the control unit 21 of the smartphone 20 stores the serial ID at that time into the storage unit 22 as the authenticated serial ID (step S48). In addition, the control unit 21 of the smartphone 20 notifies the success of the connection authentication to the on-vehicle device 10 (step S49). Thus, the on-vehicle device 10 can confirm the simultaneous connection state, and the connection authentication processing ends.

As described above, in the fourth embodiment, the server 30 executes the connection authentication processing by using the serial ID specific to the smartphone 20. When the connection authentication succeeds, the server 30 notifies the success to the on-vehicle device 10. When the serial ID does not coincide with the authenticated serial ID in the server 30, the smartphone 20 executes the simultaneous connection detection processing. In this way, the simultaneous connection state is determined by the server 30 or the smartphone 20. When the on-vehicle device 10 confirms the simultaneous connection state, it controls the smartphone 20 to inhibit display of the images during the driving of the vehicle, as necessary.

In the above embodiment, when the on-vehicle device 10 and the smartphone 20 transmit and receive the serial ID via the SPP 5 or when the smartphone 20 transmits the serial ID and the authenticated serial ID to the server 30, predetermined processing such as encryption, compression and/or addition of the specific identification information may be applied to those data.

While an example of the interface transmitting the AV data is the HDMI in the above embodiment, the present invention is not limited to this example. As another example, MHL (Mobile High-definition Link), Display Port, DVI (Digital Visual Interface) or IEEE1394 may be used. Similarly, while an example of the interface for communicating the control signals is Bluetooth in the above embodiment, the present invention is not limited to this example. As another example, a wireless LAN such as WiFi or USB (Universal Serial Bus) may be used.

[Simultaneous Connection Detection Processing]

Next, the simultaneous connection detection processing will be described in detail. As described above, the simultaneous connection detection processing is executed by the smartphone 20. Specifically, the smartphone 20 transmits predetermined authentication image to the on-vehicle device 10 to display it on the display unit 12, and detects that the on-vehicle device 10 and the smartphone 20 are in the simultaneous connection state based on the user's input to the displayed image.

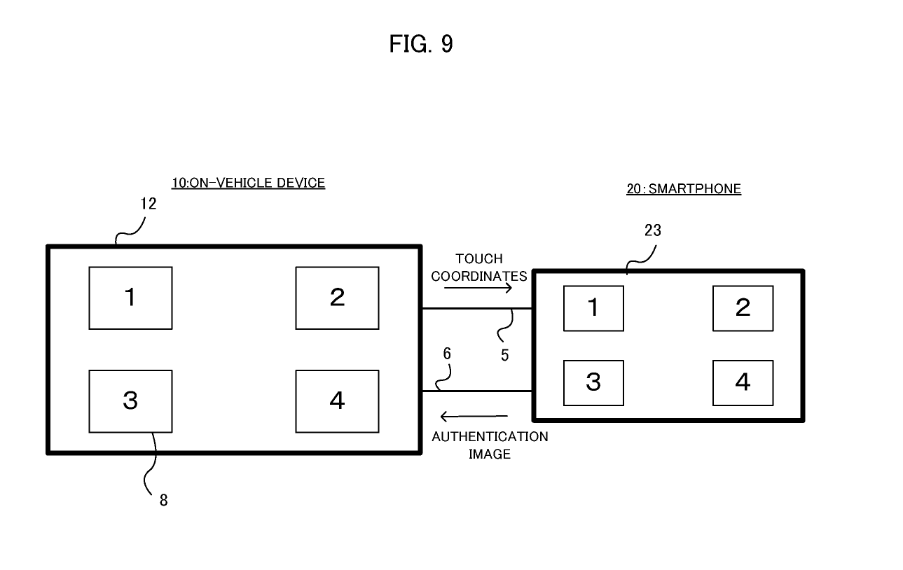

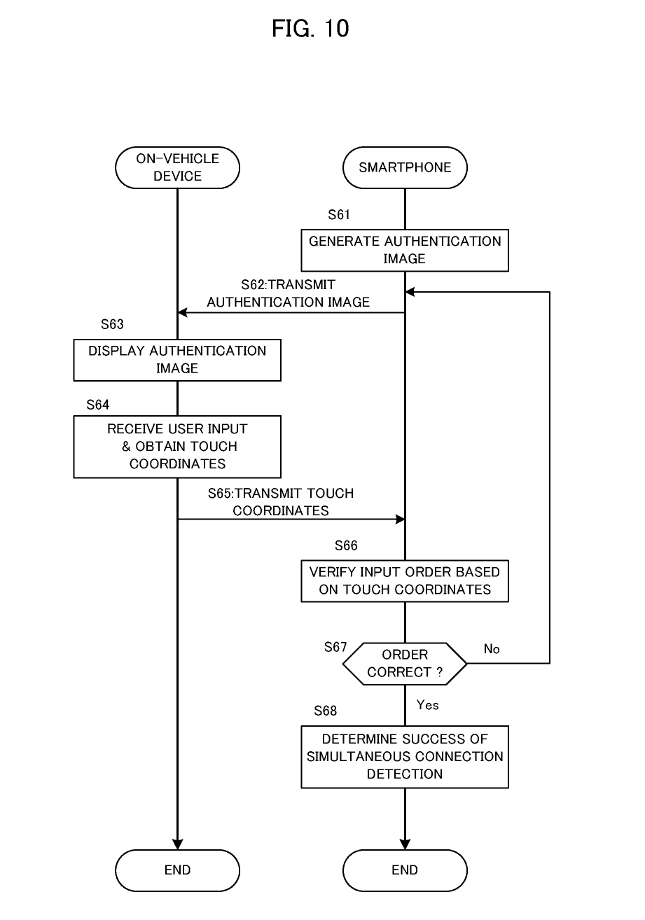

FIG. 9 shows an example of the authentication image in the simultaneous connection detection processing. FIG. 10 is a flowchart of the simultaneous connection detection processing. Now, it is assumed that the on-vehicle device 10 and the smartphone 20 are connected with each other by the SPP 5 and the HDMI 6.

The smartphone 20 generates the authentication image prepared in advance (step S61), and transmits it to the on-vehicle device 10 via the HDMI 6 (step S62). The on-vehicle device 10 displays the received authentication image on the display unit 12 (step S63). In the example shown in FIG. 9, the authentication image is an image including four touch areas 8 denoting the figures “1” to “4”. It is noted that, in this authentication image, the touch areas 8 are merely divided as the boxes and are not displayed as buttons for inputting the operation.

The user watches the authentication image displayed on the on-vehicle device 10, and touches the touch areas 8 in the order of the figures. In response, the on-vehicle device 10 obtains the coordinates (hereinafter referred to as “touch coordinates”) of the position on the display unit 12 where the user touches (step S64), and transmits them to the smartphone 20 (step S65). In the example of FIG. 9, four touch coordinates corresponding to the figures “1” to “4” are transmitted to the smartphone 20.

The smartphone 20 determines whether or not the four touch coordinates thus received correspond to the four touch areas 8, respectively, and verifies the input order of them (step S66). When the four touch areas 8 are not touched in the correct order (step S67: No), the process returns to step S62, and the process up to step S67 is repeated. On the other hand, when the four touch areas 8 are touched in the correct order (step S67: Yes), the smartphone 20 determines that the on-vehicle device 10 and the smartphone 20 are in the simultaneous connection state (step S68), and ends the processing.

As described above, in the simultaneous connection detection processing, the authentication image transmitted from the smartphone 20 to the on-vehicle device 10 via the HDMI 6 is displayed on the on-vehicle device 10, and the touch coordinates indicating the user's input to the authentication image are transmitted to the smartphone 20 via the SPP 5. Therefore, if the on-vehicle device 10 and the smartphone 20 are not simultaneously connected with each other via the SPP 5 and the HDMI 6, the smartphone 20 cannot receive the correct touch coordinates in the correct order. For example, in a case where the on-vehicle device 10 is connected with the smartphone 20 via the SPP 5 but is also connected with a DVD player via the HDMI 6, the output image of the DVD player is displayed on the display unit 12 of the on-vehicle device 10 and the authentication image from the smartphone 20 is not displayed on the display unit 12. Therefore, the user cannot touch the correct touch areas, and the simultaneous connection detection fails.

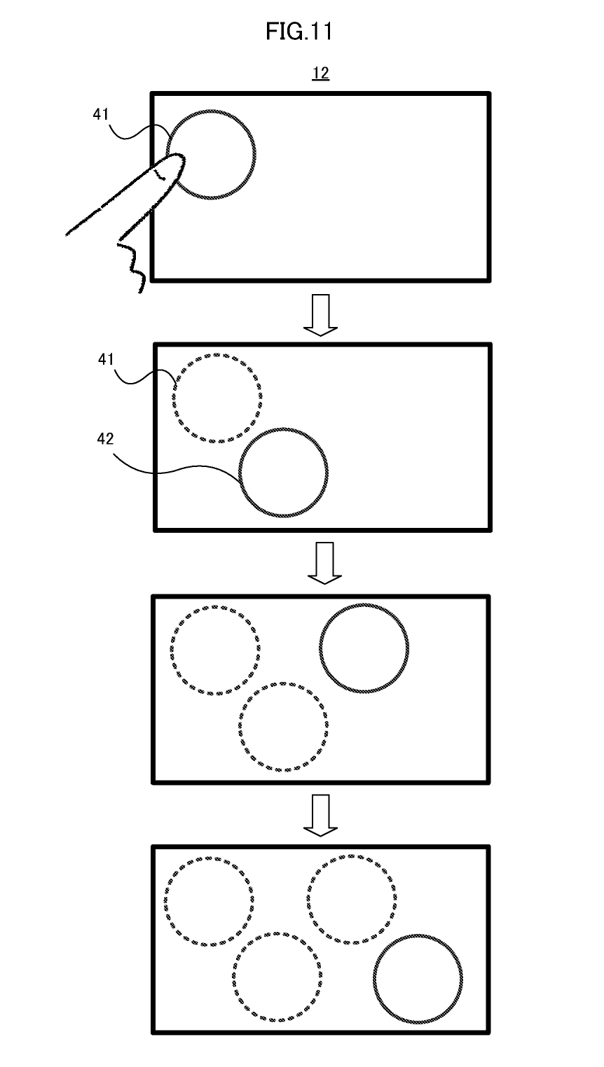

FIG. 11 shows another example of the authentication image in the simultaneous connection detection processing. In this example, as the authentication image, images indicating four touch areas are displayed one after another with a certain delay time and then disappear. The user touches the touch area 41 displayed on the display unit 12 of the on-vehicle device 10. When the on-vehicle device 10 determines that the user touches the correct touch area, it displays new touch area 42 and changes the image showing the touch area 41 to the inconspicuous image. In this way, the on-vehicle device 10 displays a new touch area every time it determines that the new touch area is correctly touched by the user. In this example, the on-vehicle device 10 transmits the touch coordinates corresponding to the display positions of four circles to the smartphone 20 one after another. The smartphone 20 verifies those positions in order, and detects the simultaneous connection state when it determines that the four touch areas are correctly touched by the user.

The authentication image used in the simultaneous connection detection processing is not limited to those examples, and it is possible to use various authentication images of the type making the user touch plural touch positions in order.

Further, the touch area may be displayed at random positions every time. By this, it is possible to prevent the user from memorizing the positions of the touch areas and touching the positions of the touch areas even when the authentication image is not displayed, for example.

### Modified Examples

In addition to the first to fourth embodiments described above, the smartphone 20 may compare the serial IDs to execute the connection authentication processing and the server 30 may store the authenticated serial ID. Further, the on-vehicle device may compare the serial IDs to execute the connection authentication processing and the server 30 may store the authenticated serial ID.

While the above embodiments authenticate that the on-vehicle device 10 and the smartphone 20 are simultaneously connected by two interfaces, it is possible to authenticate that the on-vehicle device 10 and the smartphone 20 are simultaneously connected by three or more interfaces. In that case, first the connection authentication by two interfaces is executed, and then the connection authentication of one of those two interfaces and another interface is executed.

### INDUSTRIAL APPLICABILITY

This invention can be used for a case where a smartphone is connected to an on-vehicle device such as a car navigation device.

### DESCRIPTION OF REFERENCE NUMERALS

10 On-vehicle device
11 Control unit
12 Display unit
20 Smartphone
21 Control unit
22 Storage unit
30 Server
31 Control unit
32 Storage unit

1-17. (canceled)

18. An information processing device comprising:
a first communication unit which transmits an authentication image generated by the information processing device to a display device;
a second communication unit which is different from the first communication unit and which receives information on user's operation to the authentication image displayed on the display device from the display device; and
a detection unit which detects whether or not the first communication unit and the second communication unit are simultaneously connected to the display device, based on the authentication image and the information on the user's operation.

19. The information processing device according to claim 18, further comprising a control unit,
wherein the first communication unit transmits a first identification information possessed by the information processing device to the display device, prior to the authentication image,
wherein the second communication unit receives a second identification information corresponding to the first identification information from the display device, prior to the information on the user's operation, and
wherein the control unit compares the second identification information with a third identification information stored in a storage unit to determine whether or not the first communication unit and the second communication unit are simultaneously connected to the display device, and controls the first communication unit to transmit the authentication image when it is not determined that the first communication unit and the second communication unit are simultaneously connected to the display device.

20. The information processing device according to claim 19, wherein the control unit stores the second identification information into the storage unit as the third identification information when it is determined that the first communication unit and the second communication unit are simultaneously connected to the display device.

21. The information processing device according to claim 18,
wherein the authentication image includes a touch area arranged at a random position, and
wherein the control unit obtains touch coordinates generated by a user's touch on the touch area in the authentication image displayed on the display device, and determines whether or not the first communication unit and the second communication unit are simultaneously connected to the display device, based on the touch coordinates and a position of the touch area in the authentication image.

22. A display device comprising:
a first communication unit which receives a first identification information possessed by an information processing device and an authentication image generated by the information processing device transmitted from the information processing device;
a display unit which displays the authentication image;
an obtaining unit which obtains information on user's operation to the authentication image; and
a second communication unit which is different from the first communication unit and which transmits a second identification information corresponding to the first identification information and the information on the user's operation to the information processing device.

23. The display device according to claim 22, further comprising a control unit,
wherein the first communication unit receives the first identification information from the information processing device prior to a reception the authentication image,
wherein the second communication unit receives the third identification information possessed by the information processing device from the information processing device, and
wherein the control unit compares the first identification information with the third identification information to determine whether or not the first communication unit and the second communication unit are simultaneously connected to the information processing device, and requests the information processing device to transmit the authentication image via the first communication unit when it is not determined that the first communication unit and the second communication unit are simultaneously connected to the information processing device.

24. An information processing method executed by an information processing device communicable with a display device by a first communication unit and a second communication unit different from the first communication unit, the method comprising:
a first communication process which transmits an authentication image to the display device by the first communication unit;
a second communication process which receives information on user's operation to the authentication image displayed on the display device from the display device by the second communication unit; and
a detection process which detects whether or not the first communication unit and the second communication unit are simultaneously connected to the display device, based on the authentication image and the information on the user's operation.
